(19) United States
(12) Patent Application Publication
(10) Pub. No.: US 2026/0195018 A1
(43) Pub. Date: Jul. 9, 2026

(54) TOUCH ASSEMBLY

(71) Applicant: TPK Glass Solutions (Xiamen) Inc., Fujian (CN)

(72) Inventors: Li-Huang TSAI, Miaoli County (TW); Chien-Min LAI, Taipei City (TW); Liang LIU, Xiamen City (CN); Yu-Ting CHAN, Taoyuan City (TW)

(21) Appl. No.: 19/386,648

(22) Filed: Nov. 12, 2025

(30) Foreign Application Priority Data
Jan. 6, 2025 (CN) 202510014742.8

(51) Int. Cl. G06F 3/047

(52) U.S. Cl. CPC G06F 3/047

(57) ABSTRACT

A touch assembly includes a protective cover, a first adhesive layer, a wire layer, a second adhesive layer, and a flexible circuit board. The protective cover includes a visible zone and a peripheral zone. The first adhesive layer is disposed on the visible zone. The wire layer includes curved wires disposed on the first adhesive layer. Each of the curved wires includes a conductive inner core and an outer covering. The second adhesive layer covers the curved wires and the first adhesive layer. The flexible circuit board includes a plurality of bonding pads. Each of the curved wires extends from the visible zone to the peripheral zone to form a signal transmission path including a trace section extending in a length direction and a bonding section. The bonding section is repeatedly bent within a range in a width direction, and is bonded to a corresponding one of the bonding pads.

### CROSS-REFERENCE TO RELATED APPLICATIONS

This application claims priority to Chinese Patent Application 202510014742.8, filed on Jan. 6, 2025, which is incorporated herein by reference.

### FIELD OF DISCLOSURE

The present disclosure relates to a touch assembly.

### DESCRIPTION OF RELATED ART

As diversified developments of touch modules progress, touch modules have been maturely implemented in industrial and consumer electronics products. More and more varieties of touch products have been seen embedded in medium and large-scale products.

However, the manufacturing process of the touch modules of the prior art uses indium tin oxide (ITO) as transparent electrodes. To produce ITO, the rare metal indium is required. The reserves of indium are limited, and the mining process thereof creates environmental pollution as well as a vast amount of waste during the ITO manufacturing process of the prior art. This wastes all requires proper treatment to prevent environmental pollution. In addition, the aforementioned prior art requires the vacuum deposition equipment to produce high temperatures and high pressures with high energy consumption.

Therefore, to introduce a touch assembly that can solve the aforementioned problems is what the industry invests its research and development resources in and intends to achieve.

### SUMMARY OF THE DISCLOSURE

In view of the foregoing statement, the objective of the present disclosure is to provide a touch assembly that can solve the aforementioned problems.

To achieve the aforementioned objective, according to one of the embodiments of the present disclosure, a touch assembly comprises a protective cover, a first adhesive layer, a wire layer, a second adhesive layer, and a flexible circuit board. The protective cover comprises a visible zone and a peripheral zone. The first adhesive layer is disposed on the visible zone of the protective cover. The wire layer comprises a plurality of curved wires disposed on the first adhesive layer. The curved wires comprise a first group of wires extending along a first direction and a second group of wires extending along a second direction and overlapping the first group of wires. Each of the plurality of curved wires comprises a conductive inner core and an outer covering. The wire layer is configured for touch sensing. The second adhesive layer covers the plurality of curved wires and the first adhesive layer. The flexible circuit board comprises a plurality of bonding pads. Each of the plurality of curved wires extends from the visible zone to the peripheral zone to form a signal transmission path. The signal transmission path comprises a trace section and a bonding section. The trace section extends in a lengthwise direction. The bonding section bends back and forth within a range in a widthwise direction, and is bonded to a corresponding one of the plurality of bonding pads.

In one or several embodiments of the present disclosure, the bonding section bends back and forth in a sawtooth shape.

In one or several embodiments of the present disclosure, the bonding section comprises a plurality of tooth portions sequentially connected. An included angle between two adjacent tooth portions is 10 degrees to 16 degrees.

In one or several embodiments of the present disclosure, the bonding section comprises a plurality of tooth portions sequentially connected. The number of tooth portions is 4 to 6.

In one or several embodiments of the present disclosure, the bonding section comprises a plurality of tooth portions sequentially connected. Each of the plurality of tooth portions are inclined toward a same side relative to the widthwise direction. Each of the tooth portions comprises two inclined edges connected to each other. A longest one of the two inclined edges of each of the plurality of tooth portions has a length of 0.5 mm to 1.1 mm.

In one or several embodiments of the present disclosure, the bonding sections of two adjacent signal transmission paths are staggered in the lengthwise direction.

In one or several embodiments of the present disclosure, the plurality of bonding pads are arranged in at least one row.

In one or several embodiments of the present disclosure, each of the plurality of bonding pads has a pointed tip.

In one or several embodiments of the present disclosure, each of the plurality of bonding pads has a width of 0.3 mm to 0.7 mm and a length of 0.1 mm to 6 mm. The spacing between two adjacent bonding pads is 0.3 mm to 1.1 mm.

In one or several embodiments of the present disclosure, a metal layer on the bonding pads has a thickness of 3 μm to 11 μm.

In summary, in the touch assembly of the present disclosure, through a trace design of curved wires bending back and forth within a range in a widthwise direction on the bonding section of the peripheral zone, the conductive area between the bonding section and the bonding pads of the flexible circuit board increases. This will not only improve the manufacturing process rate of welding the bonding sections and the bonding pads (especially bonding pads in medium/small sizes) of curved wires using the laser welding process, but also effectively solves the delamination problem that easily occurs while using the chip on film (COF) technology.

The aforementioned statements are only used for explaining the problems that can be solved by the present disclosure, the technical means for solving the problems, and the effect thereof. The present disclosure will become more comprehensively understood through the following detailed descriptions of the way of embodiments with reference to the accompanying diagrams.

### BRIEF DESCRIPTION OF THE DIAGRAMS

To better understand the aforementioned and other objectives, novel features, advantages, embodiments, and the effect of the present disclosure, diagrams are provided as follows:

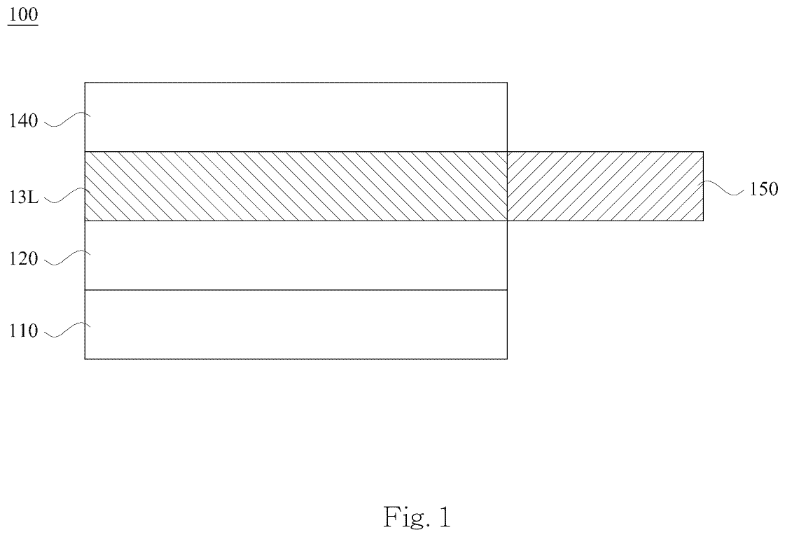

FIG. 1 is a schematic diagram illustrating the touch assembly according to an embodiment of the present disclosure.

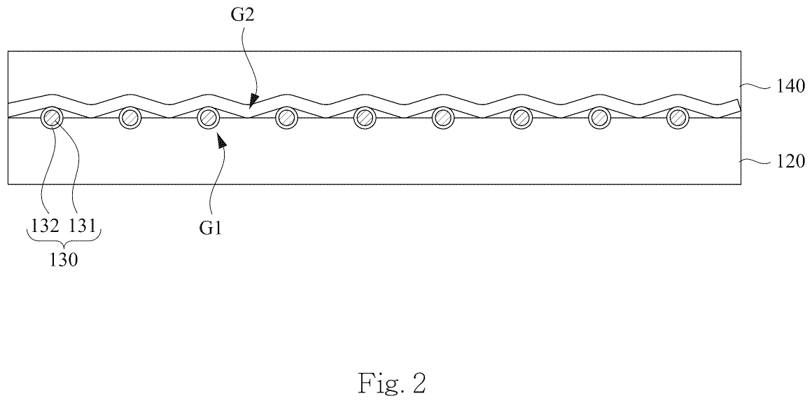

FIG. 2 is a partial cross-sectional schematic diagram illustrating some of the components of FIG. 1.

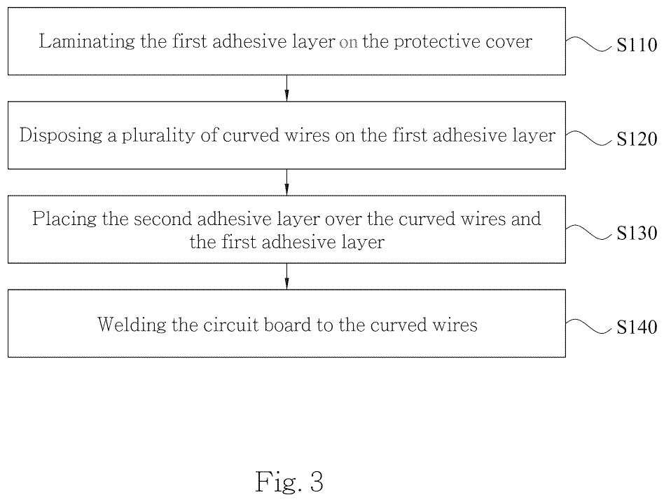

FIG. 3 is a flowchart illustrating the manufacturing method of the touch assembly according to an embodiment of the present disclosure.

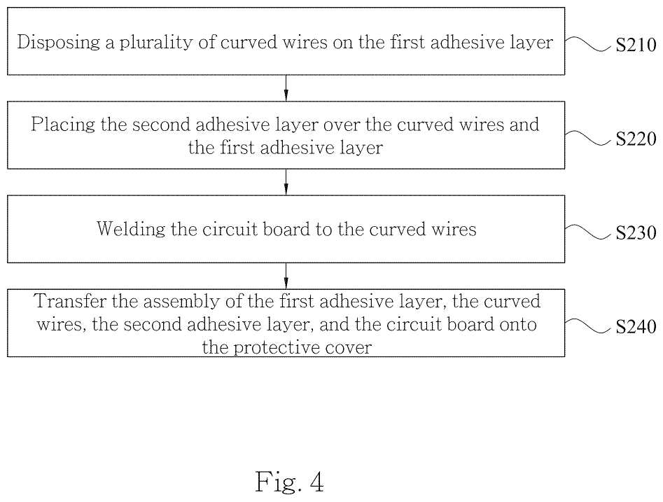

FIG. 4 is a flowchart illustrating the manufacturing method of the touch assembly according to another embodiment of the present disclosure.

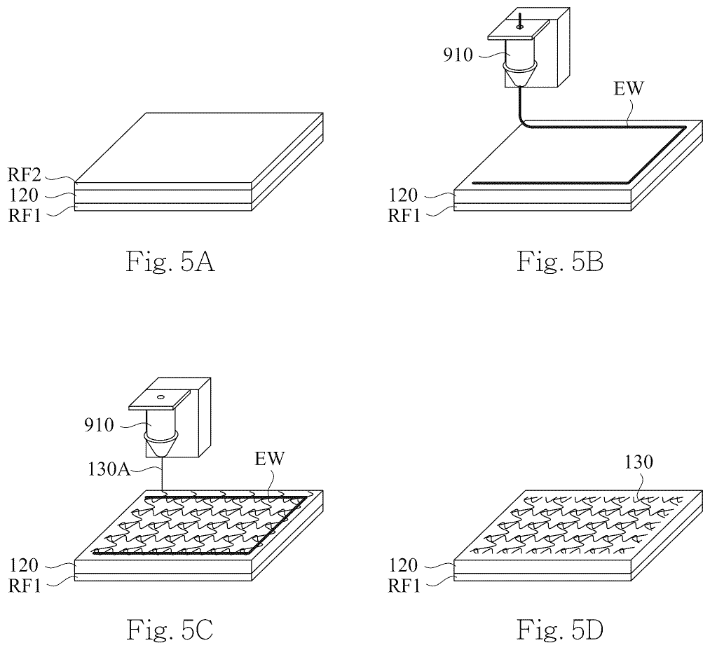

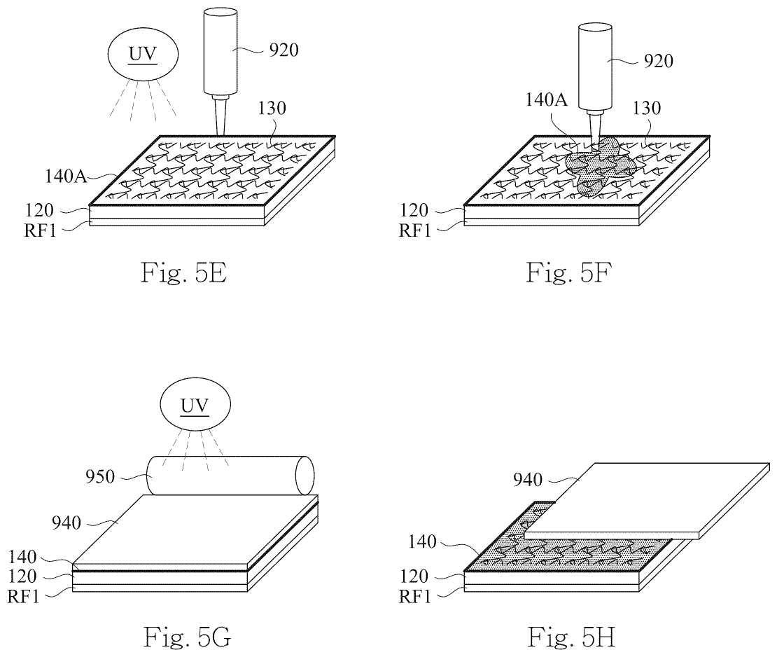

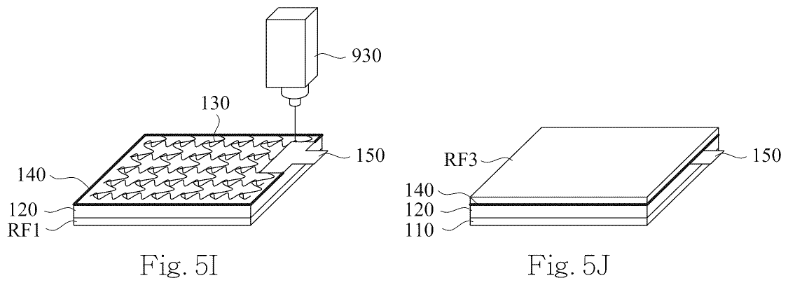

FIG. 5A to FIG. 5J are schematic diagrams illustrating the intermediate steps of the manufacturing method of the touch assembly, respectively, according to an embodiment of the present disclosure.

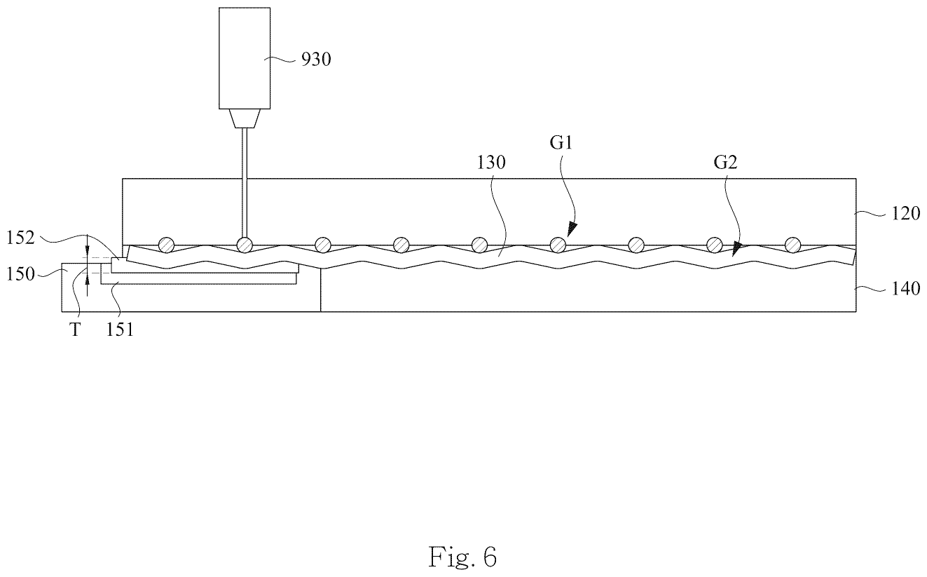

FIG. 6 is a cross-sectional schematic diagram illustrating FIG. 5I.

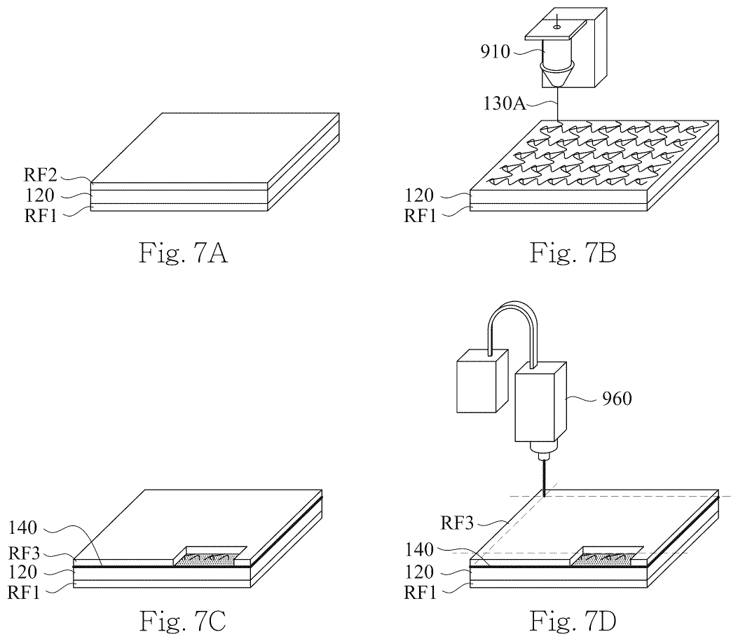

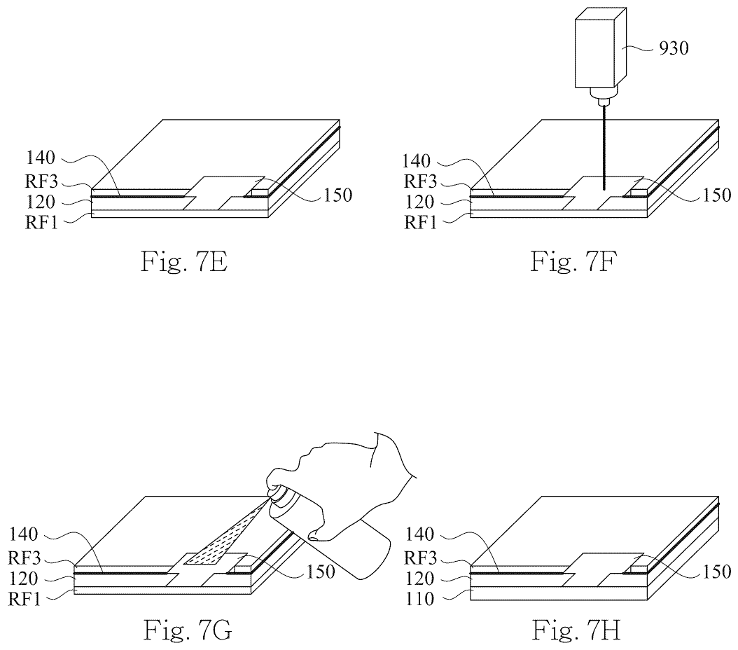

FIG. 7A to FIG. 7H are schematic diagrams illustrating the intermediate steps of the manufacturing method of the touch assembly, respectively, according to an embodiment of the present disclosure.

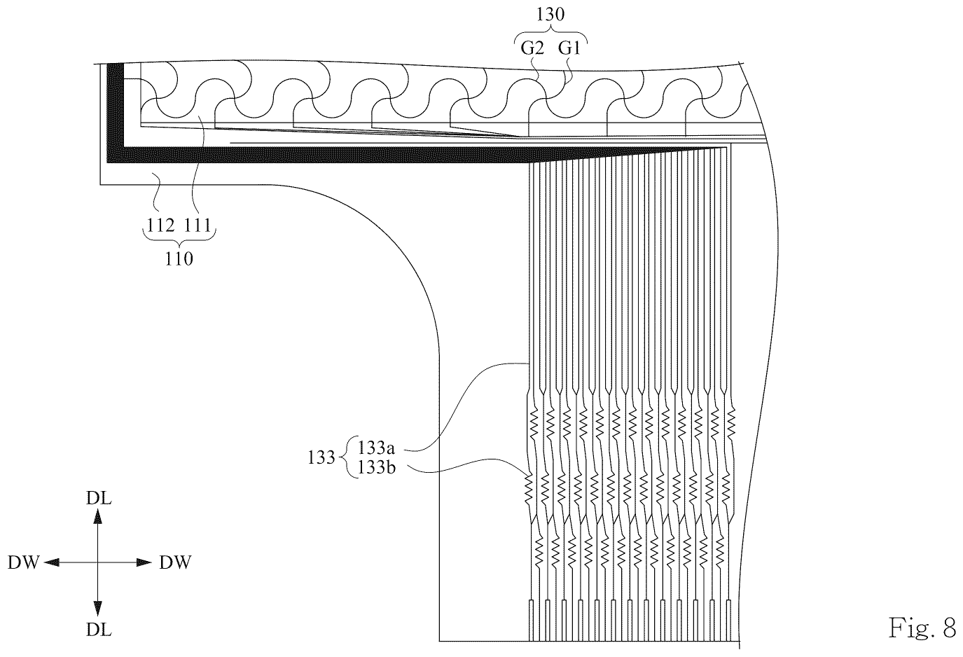

FIG. 8 is a partial schematic diagram illustrating parts of the components in FIG. 1.

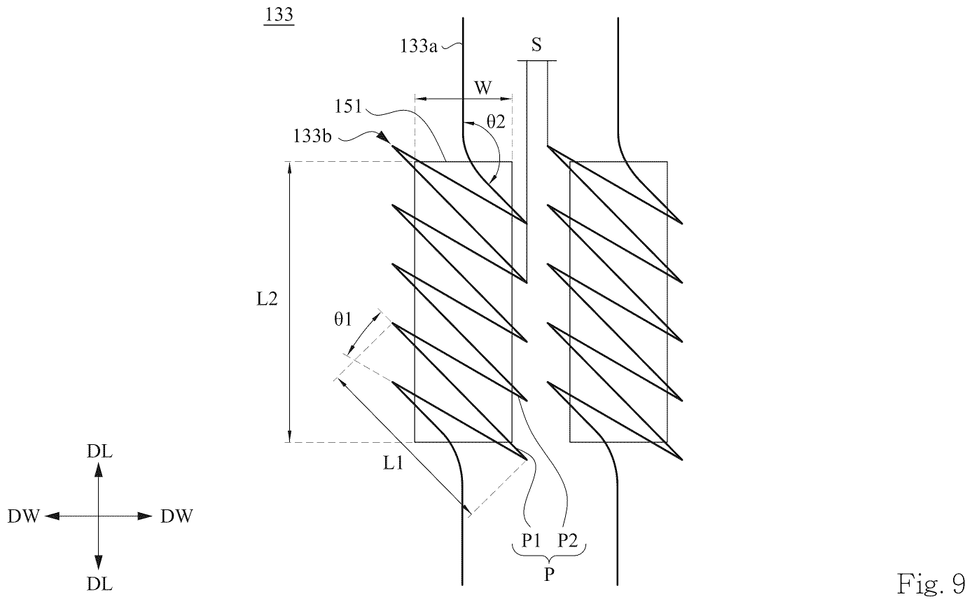

FIG. 9 is a partial schematic diagram illustrating the bonding pads and the signal transmission paths according to an embodiment of the present disclosure.

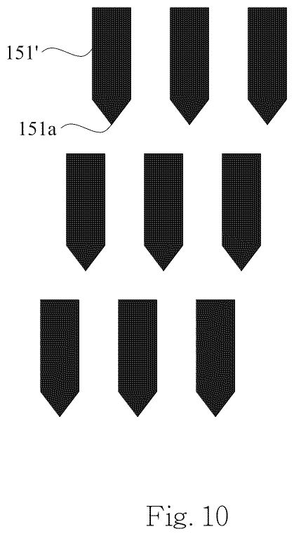

FIG. 10 is a schematic diagram illustrating some of the bonding pads according to an embodiment of the present disclosure.

### EMBODIMENTS

A plurality of embodiments of the present disclosure will be disclosed below with reference to diagrams. For the purpose of clear explanations, many details in practice will be provided together with the following descriptions. However, these detailed descriptions in practice are for illustration only and shall not be interpreted as limitations to the scope, applicability, or configuration of the present disclosure in any way. That is, in some embodiments of the present disclosure, these details in practice are not required. Furthermore, for the purpose of simplifying diagrams, some structures and components of the prior art shown in the diagrams will be illustrated schematically.

Please refer to FIG. 1 and FIG. 2. FIG. 1 is a schematic diagram illustrating the touch assembly 100 according to an embodiment of the present disclosure. FIG. 2 is a partial cross-sectional schematic diagram illustrating some of the components of FIG. 1. In the embodiment, as illustrated in FIG. 1 and FIG. 2, a touch assembly 100 comprises a protective cover 110, a first adhesive layer 120, a wire layer 13L, a second adhesive layer 140, and a flexible circuit board 150. The first adhesive layer 120 is disposed on the protective cover 110. The wire layer 13L comprises a plurality of curved wires 130 disposed on the first adhesive layer 120. The curved wires 130 are disposed on the first adhesive layer 120 and comprise a first group of wires G1 and a second group of wires G2. The first group of wires G1 extends along the first direction and is arranged with intervals. The second group of wires G2 extends along the second direction, overlaps with the first group of wires G1, and is arranged with intervals. In some embodiments, the first direction and the second direction are perpendicular to each other, for example, in the directions of the X-axis and Y-axis, respectively. The wire layer 13L is configured for touch sensing. The second adhesive layer 140 covers the curved wires 130 and the first adhesive layer 120. The flexible circuit board 150 and the curved wires 130 are electrically connected.

More specifically, as shown in FIG. 2, each curved wire 130 comprises a conductive inner core 131 and an outer covering 132. The outer covering 132 is composed of insulation materials. Therefore, the conductive inner cores 131 of the two groups, the first group of wires G1 and the second group of wires G2, can be electrically insulated by means of the outer coverings 132 of the first group of wires G1 and the second group of wires G2. Hereby, the touch signals (for example, mutual-capacitance sensing signals) between the first group of wires G1 and the second group of wires G2 can be transmitted to the flexible circuit board 150.

In the embodiment, every curved wire 130 is an enameled wire. Hereby, the curved wire 130 can be manufactured within the touch assembly 100 by wire winding technology, thus avoiding problems of high pollution and high energy consumption due to the use of ITO as the transparent electrodes in the complicated manufacture process of the prior art.

During practical implementation, the curved wires 130 can also be a combination of enameled wire and transparent electrodes of indium tin oxide (ITO). For example, one group among the first group of wires G1 and the second group of wires G2 of the curved wires 130 is composed of enameled wires, and the other group among the first group of wires G1 and the second group of wires G2 is composed of transparent electrodes of ITO.

In several embodiments, the material of the conductive inner core 131 of the curved wire 130 is composed of silver, copper, aluminum, tungsten, or similar metals.

In several embodiments, the material of the conductive inner core 131 of the curved wire 130 is composed of palladium copper alloy, silver palladium copper alloy, molybdenum rhenium alloy, aluminum alloy, nickel alloy, or similar alloys.

In several embodiments, the material of the outer covering 132 of the curved wire 130 is composed of polyvinyl formal, polyurethane, polyamide, polyester, polyester-polyimide, polyamide-polyimide, or polyimide. However, the present disclosure is not limited thereto.

In several embodiments, the wire diameter of the conductive inner core 131 of the curved wire 130 is in a range of 2 μm to 20 μm. Preferably, the wire diameter of the conductive inner core 131 is in a range of 2 μm to 5 μm to increase the visibility of the touch assembly 100 and, in other words, reduce the visibility of the curved wire 130. In several embodiments, the thickness of the outer covering 132 of the curved wire 130 is in a range of 1 μm to 3 μm. For example, in one embodiment, the wire diameter of the conductive inner core 131 is about 5 μm, whereas the thickness of the outer covering 132 is about 2 μm (that is, the wire diameter of the curved wire is about 7 μm). However, the present disclosure is not limited thereto.

In the embodiment, as shown in FIG. 2, the first adhesive layer 120 and the second adhesive layer 140 fill the intervals within the first group of wires G1 and the intervals within the second group of wires G2. Therefore, the void caused by indentation within the curved wires 130 to both the first adhesive layer 120 and the second adhesive layer 140 can be eliminated. As a result, the possibility of seeing the curved wires 130 from one side of the second adhesive layer 140 can be reduced effectively (that is, reducing the resulting shadows).

In several embodiments, at least one of the first adhesive layer 120 or the second adhesive layer 140 is an optical clear adhesive (OCA) layer or a liquid optical clear adhesive (LOCA) layer. However, the present disclosure is not limited thereto.

In several embodiments, the thickness of the second adhesive layer 140 is in a range of 25 μm to 150 μm. When the thickness of the second adhesive layer 140 is smaller than the aforementioned lower limit, the aforementioned voids will not be easily removed. When the thickness of the second adhesive layer 140 is larger than the aforementioned upper limit, it will lead to an increase in the overall volume, weight, and cost of the touch assembly 100.

Please refer to FIG. 3, which illustrates a flowchart illustrating the manufacturing method of the touch assembly according to an embodiment of the present disclosure. In the embodiment, as shown in FIG. 3 in conjunction with FIG. 1 and FIG. 2, the manufacturing method of the touch assembly comprises steps from Step S110 to Step S140.

Step S110: Laminate the first adhesive layer 120 on the protective cover 110 tightly.

In several embodiments, Step S110 is to continuously laminate the first adhesive layer 120 onto the protective cover 110 at 130 degrees Celsius for a period of 40 minutes. However, the present disclosure is not limited thereto.

In several embodiments, before Step S110, a process to form a black matrix (BM) layer on the protective cover 110 can be carried out. After Step S110 is implemented, the first adhesive layer 120 is in contact with the black matrix layer.

Step S120: Dispose a plurality of curved wires 130 on the first adhesive layer 120.

In several embodiments, Step S120 comprises: winding enameled wire 130A (in reference to FIG. 5C and FIG. 7B) onto the first adhesive layer 120; and cutting enameled wire 130A to form curved wires 130.

In several embodiments, the step of cutting the enameled wire 130A to form curved wires 130 is carried out through a laser cutting process. However, the present disclosure is not limited thereto.

Step S130: Place the second adhesive layer 140 over the curved wires 130 and the first adhesive layer 120.

In several embodiments, Step S130 is to continuously laminate the second adhesive layer 140 onto the first adhesive layer 120 at 130 degrees Celsius for a period of 40 minutes. However, the present disclosure is not limited thereto.

Step S140: Weld the flexible circuit board 150 to the curved wires 130.

In several embodiments, Step S140 is carried out through a laser welding process. However, the present disclosure is not limited thereto.

Please refer to FIG. 4, which illustrates a flowchart illustrating the manufacturing method of the touch assembly according to another embodiment of the present disclosure. In the embodiment, as shown in FIG. 4 in conjunction with FIG. 1 and FIG. 2, the manufacturing method of the touch assembly comprises steps from Step S210 to Step S240.

Step S210: Dispose a plurality of curved wires 130 on the first adhesive layer 120.

In several embodiments, Step S210 comprises: winding enameled wire 130A (in reference to FIG. 5C and FIG. 7B) onto the first adhesive layer 120; and cutting enameled wire 130A to form curved wires 130.

Step S220: Place the second adhesive layer 140 over the curved wires 130 and the first adhesive layer 120.

In several embodiments, Step S220 is to continuously laminate the second adhesive layer 140 onto the first adhesive layer 120 at 130 degrees Celsius for a period of 40 minutes. However, the present disclosure is not limited thereto.

Step S230: Weld the flexible circuit board 150 to the curved wires 130.

In several embodiments, Step S230 is carried out through a laser welding process. However, the present disclosure is not limited thereto.

Step S240: Transfer the assembly of the first adhesive layer 120, the curved wires 130, the second adhesive layer 140, and the flexible circuit board 150 onto the protective cover 110.

In comparison to the embodiment shown in FIG. 3, the embodiment illustrated in FIG. 4 is to transfer the assembly of the first adhesive layer 120, the curved wires 130, and the second adhesive layer 140 onto the protective cover 110 after the laminating process of the second adhesive layer 140, so that the problem of the black matrix layer disposed on the protective cover 110 being damaged by the high temperature during the laminating process can be effectively prevented.

Please refer to FIG. 5A to FIG. 5J. FIG. 5A to FIG. 5J are schematic diagrams illustrating the intermediate steps of the manufacturing method of the touch assembly, respectively, according to an embodiment of the present disclosure. The embodiment is one specific embodiment of the manufacturing method illustrated in FIG. 4, and the descriptions are provided as follows.

In the step, as illustrated in FIG. 5A, both the surfaces of the first adhesive layer 120 opposite to each other are pasted with the separation films, RF1 and RF2, respectively.

As shown in FIG. 5B, this step follows the step shown in FIG. 5A. In this step, the separation film RF2 is peeled off, then the pre-embedded wire EW is disposed on the surface of the first adhesive layer 120 that was originally pasted with the separation film RF2. The pre-embedded wire EW can be wound on the first adhesive layer 120 by the winding machine 910. The pre-embedded wire EW shows a U-shape after the winding process, as shown in FIG. 5B. However, the present disclosure is not limited thereto.

As shown in FIG. 5C, this step follows the step shown in FIG. 5B. In this step, the enameled wire 130A is wound on the first adhesive layer 120. The winding method is, for example, to wind the enameled wire 130A back and forth along a route on the first adhesive layer 120, so that the enameled wire 130A partially covers the pre-embedded wire EW. Specifically, as shown in FIG. 5C, the enameled wire 130A is disposed on the first adhesive layer 120 in a checkerboard pattern, and three edges of the checkerboard pattern overlap the pre-embedded wire EW.

As shown in FIG. 5D, this step follows the step shown in FIG. 5C. In this step, a single enameled wire 130A is cut to form a plurality of curved wires 130. Specifically, this step can cause the enameled wire 130A to break up and form curved wires 130 through the action of peeling the pre-embedded wire EW from the first adhesive layer 120. The mechanism of peeling the pre-embedded wire EW to cause the enameled wire 130A to break up is similar to the action of pulling the tear tape on the cellophane wrapper of a cigarette pack. In comparison to the method that uses cutlery to cut the enameled wire 130A, the present step will not leave tool marks on the first adhesive layer 120. Therefore, Step S210 can be implemented by executing the steps illustrated in FIG. 5B, FIG. 5C, and FIG. 5D in sequence.

In several embodiments, the wire diameter of the pre-embedded wire EW is larger than the wire diameter of the enameled wire 130A. Hereby, the thicker pre-embedded wire EW has higher tensile strength than that of the thinner enameled wire 130A, so that during the process of peeling the pre-embedded wire EW, which forces the enameled wire 130A to break up, the pre-embedded wire EW will not also break up. In one embodiment, the wire diameter of the pre-embedded wire EW is about 20 μm, and the wire diameter of the enameled wire 130A is about 5 μm. However, the present disclosure is not limited thereto.

As shown in FIG. 5E, this step follows the step shown in FIG. 5D. In this step, the hydrogel 140A is coated on the first adhesive layer 120 using a glue spreader 920. Specifically, the hydrogel 140A is coated on the outer edge of the first adhesive layer 120. In several embodiments, the hydrogel 140A is a type of light-curable gel. For example, the light-curable gel is hardened after being exposed to ultraviolet (UV) light. Hereby, when UV light exposure simultaneously occurs during this step, and the hydrogel 140A coated on the outer edge of the first adhesive layer 120 is hardened and becomes an outer wall.

As shown in FIG. 5F, this step follows the step shown in FIG. 5E. In this step, the hydrogel 140A is further coated over the first adhesive layer 120 using the glue spreader 920 to cover the curved wires 130. In other words, the hydrogel 140A is coated over and filled in the space within the aforementioned outer wall in this step. In other embodiments, methods of glue scraping, dispensing, slitting, filling, or similar coating methods can be applied.

As shown in FIG. 5G, this step follows the step shown in FIG. 5F. In this step, plate 940 is placed on and covers the hydrogel 140A, and the plate 940 is rolled and pressed by a roller 950. Hereby, when light exposure also occurs during this step, the hydrogel 140A is hardened into the second adhesive layer 140 of uniform thickness.

As shown in FIG. 5H, this step follows the step shown in FIG. 5G. In this step, after the hydrogel 140A is hardened into the second adhesive layer 140, the plate 940 can then be removed. Therefore, step S220 can be implemented by executing steps illustrated in FIG. 5E, FIG. 5F, FIG. 5G, and FIG. 5H in sequence.

As shown in FIG. 5I, this step follows the step shown in FIG. 5H. In this step, the flexible circuit board 150 is welded to the curved wires 130 (that is, step S230).

Please refer to FIG. 6, which illustrates a cross-sectional schematic diagram illustrating FIG. 5I. As shown in FIG. 6, the flexible circuit board 150 is welded to the curved wires 130 using a welding machine 930. The flexible circuit board 150 has bonding pads 151 disposed thereon. The bonding pads 151 have a metal layer 152 disposed thereon. For example, materials of the metal layer 152 are composed of tin. However, the present disclosure is not limited thereto. For example, the welding machine 930 is a laser welding machine. The laser can penetrate the first adhesive layer 120 and the second adhesive layer 140, hitting the curved wires 130 in contact with the metal layer 152. In several embodiments, the melting point of the outer covering 132 of the curved wire 130 is lower than the melting point of the metal layer 152. Therefore, the high temperature created by the laser causes the outer covering 132 to vaporize so that the conductive inner core 131 of the curved wire 130 is exposed. Then, the metal layer 152 is melted and welded to the conductive inner core 131.

As shown in FIG. 5J, this step follows the step shown in FIG. 5I. In this step, the assembly of the first adhesive layer 120, the curved wires 130, the second adhesive layer 140, and the flexible circuit board 150 is transferred onto the protective cover 110 (that is, Step S240). In the embodiment shown in FIG. 5J, the aforementioned assembly has the separation film RF1 peeled off and is then laminated to the protective cover 110 through the first adhesive layer 120 as a means of transfer. In addition, in this step, the separation film RF3 is pasted to the second adhesive layer 140 to protect the second adhesive layer 140.

Please refer to FIG. 7A to FIG. 7H. FIG. 7A to FIG. 7H are the schematic diagrams illustrating the intermediate steps of the manufacturing method of the touch assembly, respectively, according to an embodiment of the present disclosure. This embodiment is one specific embodiment of the manufacturing method illustrated in FIG. 4, and descriptions are provided as follows.

In this step, as shown in FIG. 7A, both the surfaces of the first adhesive layer 120 opposite to each other are pasted with the separation films RF1 and RF2, respectively.

As shown in FIG. 7B, this step follows the step shown in FIG. 7A. In this step, the separation film RF2 is peeled off, and then the enameled wire 130A is wound on the first adhesive layer 120. The winding method is, for example, to wind the wire back and forth and around along a route on the first adhesive layer 120. Specifically, as shown in FIG. 7B, the wound enameled wire 130A is disposed on the first adhesive layer 120 in a checkerboard pattern.

As shown in FIG. 7C, this step follows the step shown in FIG. 7B. In this step, the second adhesive layer 140 having the separation film RF3 is pasted to the first adhesive layer 120. More specifically, the second adhesive layer 140 is pasted to the first adhesive layer 120 on the side away from the separation film RF3 to cover the first adhesive layer 120 and the enameled wire 130A. In other words, the assembly of the first adhesive layer 120, the enameled wire 130A, and the second adhesive layer 140 is stacked between the separation film RF1 and the separation film RF3. In comparison with the second adhesive layer 140 shown in FIG. 5H, which is formed by hardening the hydrogel 140A, the second adhesive layer 140 in this step is formed by a sheet of gel.

As shown in FIG. 7D, this step follows the step shown in FIG. 7C. In this step, the enameled wire 130A is cut to form a plurality of curved wires 130 using a slitter 960. For example, the slitter 960 is a laser slitter. When the enameled wire 130A is cut by laser to form curved wires 130 (that is, loop cutting), the first adhesive layer 120, the second adhesive layer 140, and the separation films RF1 and RF3 are also cut by laser simultaneously (that is, shape cutting). In comparison with the method of cutting the enameled wire 130A using cutlery, this step will not lead to the problem of pulling gel at the edge of the cutting area of the separation films RF1 and RF3. Therefore, both step S210 and step S220 can be implemented simultaneously by executing the steps illustrated in FIG. 7B, FIG. 7C, and FIG. 7D in sequence.

In several embodiments, the laser used in the slitter 960 is a picosecond laser, femtosecond laser, CO₂ laser, or similar light source. However, the present disclosure is not limited thereto.

As shown in FIG. 7E, this step follows the step shown in FIG. 7D. In this step, the flexible circuit board 150 and an area of the second adhesive layer 140 exposed from the separation film RF3 undergo alignment so that the flexible circuit board 150 is in contact with the second adhesive layer 140.

As shown in FIG. 7F, this step follows the step shown in FIG. 7E. In this step, the flexible circuit board 150 is welded to the curved wires 130 by the welding machine 930. As relevant explanations of the welding process can be found in FIG. 6, the aforementioned descriptions will not be repeated here. Therefore, step S230 can be implemented by executing the steps illustrated in FIG. 7E and FIG. 7F in sequence.

As shown in FIG. 7G, this step follows the step shown in FIG. 7F. In this step, the flexible circuit board 150 can be coated with protection paint after welding. Protection paint is, for example, three anti-glue. However, the present disclosure is not limited thereto. In several embodiments, the step shown in FIG. 5I is followed by this step.

As shown in FIG. 7H, this step follows the step shown in FIG. 7G. In this step, the assembly of the first adhesive layer 120, the curved wires 130, the second adhesive layer 140, and the flexible circuit board 150 is transferred onto the protective cover 110 (that is, step S240). In the embodiment shown in FIG. 7H, the aforementioned assembly has the separation film RF1 peeled off and is then replaced onto the protective cover 110 by having the first adhesive layer 120 laminated thereto as a means of transfer. The separation film RF3 is still pasted to the second adhesive layer 140 to protect the second adhesive layer 140.

Please refer to FIG. 8, which illustrates a partial schematic diagram illustrating parts of the components in FIG. 1. Specifically, FIG. 8 illustrates the protective covering 110 and the wire layer 13L of the touch assembly 100. As shown in FIG. 8, the protective covering 110 comprises a visible zone 111 and a peripheral zone 112. Each of the curved wires 130 extends from the visible zone 111 to the peripheral zone 112 to form a signal transmission path 133. The signal transmission path 133 comprises a trace section 133a and a bonding section 133b. One end of the trace section 133a is connected with one end of the bonding section 133b. The trace section 133a extends in a lengthwise direction DL. The bonding section 133b bends back and forth within a range in a widthwise direction DW and is bonded to the corresponding bonding pads 151. Hereby, the conductive area between the bonding section 113b and the bonding pads 151 of the flexible circuit board 150 increases. This will not only improve the manufacturing process rate of welding the bonding sections 133b and the bonding pads 151 (especially the bonding pads 151 in medium/small size) of curved wires 130 using the laser welding process, but also effectively solves the delamination problem that easily occurs while using the chip on film (COF) technology. Additionally, due to the curved wires 130 being enameled wires, the curved wires 130 can overlap in a vertical direction (for example, the z-axis direction) when extending from the visible zone 111 to the peripheral zone 112, which helps reduce the width of the frame border of the touch assembly 100.

Please refer to FIG. 9, which illustrates a partial schematic diagram illustrating the bonding pads 151 and the signal transmission paths 133 according to an embodiment of the present disclosure. As shown in FIG. 9, the bonding section 133b bends back and forth in a sawtooth shape. Hereby, the overlapping area between the bonding pads 151 of a specific size and the bonding section 133b can increase.

More specifically, the bonding section 133b comprises a plurality of tooth portions P sequentially connected. Each tooth portion P has two adjacent inclined edges, P1 and P2, as well as a tooth tip formed by the two inclined edges P1 and P2. The inclined edges P1 of each tooth portion P are parallel to one another and close to the lower side of FIG. 9, whereas the inclined edges P2 are parallel to one another and close to the upper side of FIG. 9. In several embodiments, as shown in FIG. 9, the tips on the left side of the bonding section 133b can be unitarily considered as the tooth tips of the tooth portions P. However, the present disclosure is not limited thereto. In other embodiments, the tips on the right side of the bonding section 133b can be unitarily considered as the tooth tips of the tooth portions P.

In several embodiments, an included angle θ1 between two adjacent tooth portions P is 10 degrees to 16 degrees. Please note that, when the included angle θ1 is larger, although the pitch stability increases during winding, the conductive area between the bonding section 133b and the bonding pads 151 will decrease. On the contrary, when the included angle θ1 is smaller, although the conductive area between the bonding section 133b and the bonding pads 151 will increase, the pitch stability reduces during winding. Therefore, by setting the included angle θ1 within the aforementioned range, a better balance between “pitch stability” and “conductive area”can be achieved.

In several embodiments, the tooth portion P of every bonding section 133b is inclined toward the same side relative to the widthwise direction DW. For example, in FIG. 9, the tooth portions P are inclined upward relative to the widthwise direction DW. Therefore, the two inclined edges P1 and P2 of each tooth portion P, are not equal in length, wherein the longest one of the inclined edges, P1, has a length of 0.5 mm to 1.1 mm. Furthermore, as shown in FIG. 9, the trace section 133a and the adjacent bonding section 133 b have another included angle θ2. The included angle θ2 is 134 degrees to 156 degrees. Under the conditions of the aforementioned configuration, this is another method to achieve a better balance between “pitch stability” and “conductive area”.

In several embodiments, each of the bonding pads 151 has a width W of 0.3 mm to 0.7 mm in the widthwise direction DW and a length L2 of 0.1 mm to 6 mm in the lengthwise direction DL. A spacing S between two adjacent bonding pads 151 is 0.3 mm to 1.1 mm. The bonding pads 151 that meet the aforementioned dimensions belong to a configuration of a smaller size and compact arrangement, therefore reducing the occupied area of the bonding pads 151 on the flexible circuit board 150. As a result, the size of the flexible circuit board 150 can be reduced.

In several embodiments, the number of the tooth portions P of each bonding section 133 b is 4 to 6, so that all tooth portions P have a better overlay with the bonding pads 151 of aforementioned dimensions. To elaborate, although the pitch stability increases during winding when there are fewer tooth portions P of the bonding pads 151 corresponding to the aforementioned dimensions, the conductive area between the bonding section 133b and the bonding pads 151 will also decrease. On the contrary, although the conductive area between the bonding section 133b and the bonding pads 151 will increase when there are more tooth portions P of the bonding pads 151 corresponding to the aforementioned dimensions, the pitch stability reduces during winding. Therefore, by having the number of tooth portions P within the aforementioned range, this is another method to achieve a better balance between “pitch stability” and “conductive area”.

In several embodiments, as shown in FIG. 8, the bonding sections 133b of two adjacent signal transmission paths 133 are respectively staggered in the lengthwise direction DL. In other words, the bonding sections 133b of two adjacent signal transmission paths 133 do not correspond in the widthwise direction DW. Hereby, the space can be effectively utilized and prevent the overall occupied area of the signal transmission paths 133 from being overly large.

Please refer to FIG. 10, which illustrates a schematic diagram illustrating some bonding pads 151′ according to an embodiment of the present disclosure. As shown in FIG. 10, the bonding pads 151′ are arranged in three rows to correspond to the layout of the bonding section 133b in FIG. 8. However, the present disclosure is not limited thereto. In actual applications, the bonding pads 151′ can be arranged in different numbers of rows (for example, a single row) according to the actual design requirement.

In several embodiments, as shown in FIG. 10, every bonding pad 151′ has a pointed tip 151a. Hereby, during the laser welding process, the pointed tip 151a of the bonding pad 151′ can be used as an alignment mark when the image recognition device undergoes alignment.

As shown in FIG. 6 again, in several embodiments, the metal layer 152 on the bonding pads 151 is a solder paste with a thickness T of 3 μm to 11 μm. Please note that when the thickness T thereof is thinner than 3 μm, the welding yield rate of welding the bonding pads 151 and the bonding section 133b may decrease. On the contrary, when the thickness T thereof is thicker than 11 μm, a spatter problem may occur in the metal layer 152 during the laser welding process, which also may affect the welding yield rate.

According to the aforementioned descriptions of specific embodiments of the present disclosure, it is apparent that, in the touch assembly of the present disclosure, through a trace design of curved wires bending back and forth within a range in a widthwise direction on the bonding section of the peripheral zone, the conductive area between the bonding section and the bonding pads of the flexible circuit board increases. This will not only improve the manufacturing process rate of welding the bonding sections and the bonding pads (especially bonding pads in medium/small size) of curved wires using the laser welding process, but also effectively solves the delamination problem that easily occurs while using the chip on film (COF) technology.

The above preferred embodiments are presented to disclose the present disclosure and shall not be interpreted to limit the scope, applicability, or configuration of the present disclosure in any way. Those skilled in the art may use any alternative embodiments that are modified or changed without departing from the spirit and scope of the present disclosure and shall be included in the appended claims.

### COMPONENT SYMBOL

100, 200: Touch assembly
110: Protective cover
111: Visible zone
112: Peripheral zone
120: First adhesive layer
13L: Wire layer
130: Curved wire
130A: Enameled wire
131: Conductive inner core
132: Outer covering
133: Signal transmission path
133a: Trace section
133b: Bonding section
140: Second adhesive layer
140A: Hydrogel
150: Flexible circuit board
151,151′: Bonding pads
151a: Pointed tip
152: Metal layer
910: Winding machine
920: Glue spreader
930: Welding machine
940: Plate
950: Roller
960: Slitter
DL: Lengthwise direction
DW: Widthwise direction
EW: Pre-embedded wire
G1: First group of wires
G2: Second group of wires
L1, L2: Length
P: Tooth portion
P1, P2: Incline edge
RF1, RF2, RF3: Separation film
S: Spacing
S110, S120, S130, S140, S210, S220, S230, S240: Steps
T: Thickness
W: Width
θ1, θ2: Included angle

What is claimed is:

1. A touch assembly, comprising:
a protective cover, comprising a visible zone and a peripheral zone;
a first adhesive layer, disposed on the visible zone of the protective cover;
a wire layer, comprising a plurality of curved wires disposed on the first adhesive layer, the plurality of curved wires comprising a first group of wires extending along a first direction and a second group of wires extending along a second direction and overlapping the first group of wires, wherein each of the plurality of curved wires comprises a conductive inner core and an outer covering, and the wire layer is configured for touch sensing;
a second adhesive layer, covering the plurality of curved wires and the first adhesive layer; and
a flexible circuit board, comprising a plurality of bonding pads,
wherein each of the plurality of curved wires extends from the visible zone to the peripheral zone to form a signal transmission path, and the signal transmission path comprising a trace section and a bonding section, the trace section extending in a lengthwise direction, and the bonding section bending back and forth within a range in a widthwise direction and bonded to a corresponding one of the plurality of bonding pads.

2. The touch assembly of claim 1, wherein the bonding section bends back and forth in a sawtooth shape.

3. The touch assembly of claim 2, wherein the bonding section comprises a plurality of tooth portions sequentially connected; and an included angle between two adjacent tooth portions is 10 degrees to 16 degrees.

4. The touch assembly of claim 2, wherein the bonding section comprises a plurality of tooth portions sequentially connected; and a number of the tooth portions is 4 to 6.

5. The touch assembly of claim 2, wherein the bonding section comprises a plurality of tooth portions sequentially connected, each of the plurality of tooth portions being inclined toward a same side relative to the widthwise direction, each of the plurality of tooth portions comprising two inclined edges connected to each other, and a longest one of the two inclined edges of each of the plurality of tooth portions has a length of 0.5 mm to 1.1 mm.

6. The touch assembly of claim 1, wherein the bonding sections of two adjacent signal transmission paths are staggered in the lengthwise direction.

7. The touch assembly of claim 1, wherein the plurality of bonding pads are arranged in at least one row.

8. The touch assembly of claim 1, wherein each of the plurality of bonding pads has a pointed tip.

9. The touch assembly of claim 1, wherein each of the plurality of bonding pads has a width of 0.3 mm to 0.7 mm and a length of 0.1 mm to 6 mm, and a spacing between two adjacent ones of the plurality of bonding pads is 0.3 mm to 1.1 mm.

10. The touch assembly of claim 1, wherein a metal layer on the plurality of bonding pads has a thickness of 3 μm to 11 μm.
